(19) United States
(12) Patent Application Publication
(10) Pub. No.: US 2006/0209009 A1
(43) Pub. Date: Sep. 21, 2006

(54) Color electrophoretic display

(75) Inventors: Lucas Josef Maria Schlangen, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/551,314

(22) PCT Filed: Mar. 26, 2004
(86) PCT No.: PCT/IB04/50343

§ 371 Date: Sep. 28, 2005

(30) Foreign Application Priority Data
Apr. 3, 2003 (EP) 03100887.3

(51) Int. Cl. G09G 3/34

(52) U.S. Cl. 345/107

(57) ABSTRACT

A color electrophoretic display has pixels which each comprise an image volume (IV) and a reservoir volume (RV). Different types of particles (Pf, Pm, Ps; Pa, Pb, Pc) which have different colors and different electrophoretic mobilities are present in each one of the pixels. The particles (Pf, Pm, Ps; Pa, Pb, Pc) which are present in the image volume (IV) determine a visible color of the pixel (10), and the particles (Pf, Pin, Ps; Pa, Pb, Pc) which are present in the reservoir volume (RV) do not contribute to the visible color of the pixel (10). The color electrophoretic display is driven to operate either in: a first mode wherein all the types of particles (Pf, Pin, Ps; Pa, Pb, Pc) contribute to a change of color of at least some of the pixels, or a second mode wherein only a subset of the types of particles (Pf, Pin, Ps; Pa, Pb, Pc) contribute to the change of the color of at least some of the pixels.

The invention relates to a color electrophoretic display, a method of driving a color electrophoretic display, and a display apparatus comprising such a color electrophoretic display.

U.S. Pat. No. 6,271,823 discloses a reflective electrophoretic color display. The display comprises pixel elements (also referred to as pixels) adjacently located in a plane. The pixels comprise at least two sub-pixels or cells which are also adjacently located in the same plane. The different cells of a pixel reflect a different color. The color of a pixel is determined by the additive mixture of the colors reflected by each of its respective cells.

Each cell comprises a light-transmissive front window, a non-obstructing counter electrode, a light-reflective panel, a color filter medium, and a suspension of charged, light-absorbing pigment particles in a light-transmissive fluid.

The amount of colored light reflected by each cell is controlled by the position of the pigment particles within the cell by applying appropriate voltages to the collecting and counter electrodes. When the pigment particles are positioned in the path of the light, the light is significantly attenuated before emerging from the front window, and the viewer sees a dim color or black. When the pigment particles are substantially removed form the path of the light, light can be reflected back through the front window to the viewer without significant attenuation, and the viewer sees the color transmitted by the color filter medium. The color filter medium can, for example, be a light-transmissive colored filter element, a colored light-reflecting panel, or the pigment suspension fluid itself.

It is an object of the invention to provide a color electrophoretic display which has a higher refresh rate or lower power consumption when displaying display information which does not require use of all the different colored pigment particles.

A first aspect of the invention provides an electrophoretic display as claimed in claim 1. A second aspect of the invention provides a method of driving an electrophoretic display as claimed in claim 14. A third aspect of the invention provides a display apparatus comprising such an electrophoretic display as claimed in claim 16. Advantageous embodiments of the invention are defined in the dependent claims.

In the color electrophoretic display in accordance with the first aspect of the invention the particles which have different colors have different mobilities.

The color electrophoretic display comprises a driver which supplies drive voltages to the pixels to operate the color electrophoretic display either in a first mode wherein all the types of particles contribute to a change of color of at least some of the cells, or a second mode wherein only a subset of the types of particles contribute to the change of the color of at least some of the cells. For example, in the first mode a full color image is displayed, and in the second mode a monochrome image is displayed. Because in the second mode not all the differently colored particles have to be moved to contribute to the image displayed, the refresh rate can be increased, or at the same refresh rate, the power consumption will decrease. The effect is maximal if only the fastest particles are used during the second mode.

The higher refresh rate is in particular relevant when monochrome video is displayed on a full color E-paper display which has in the full color mode a relatively low refresh rate.

In contrast, the prior art electrophoretic color display always addresses all of the sub-pixels of the pixels independent on the amount of colors required to display the image, and thus always uses all the different colored pigment particles. The display of monochrome video will show strong motion artifacts due to the low refresh rate.

In an embodiment in accordance with the invention as claimed in claim 2, the electrophoretic display has pixels which each comprise an image volume and reservoir volume. Each of the pixels is filled with different types of particles having different colors and different electrophoretic mobilities. The particles determine a visible color of the pixel when present in the image volume, the particles do not contribute to the visible color of the pixel when present in the reservoir volume. The color electrophoretic display further comprises a driver which supplies drive voltages to the pixels to operate the color electrophoretic display either in a first mode wherein all the types of particles contribute to a change of color of at least some of the cells, or a second mode wherein only a subset of the types of particles contribute to the change of the color of at least some of the cells. Which particles are moved from the reservoir volume into the image volume depends on the color a particular pixel should get in accordance with an image to be displayed. However, as there may exist pixels which require a move of all types of particles into the image volume, all the types of particles have to be selected during a select period and for every selected type of particle a fill period should be available to move the selected type of particles into the image area

In the first mode, all the different colored particles are selected in the reservoir volume to be moved into the image volume. Which types of particles are actually moved into the image volume in which quantity depends on the image to be displayed.

In the second mode, not all the different colored particles are selected in the reservoir volume to be moved into the image volume because the image has colors which allow using only a subset of the available types of particles.

For example, in the first mode, when all the particle types are available to be moved into the image volume, a full color image can be displayed. Usually, it suffices to have three types of particles which usually are colored magenta, yellow, and cyan. In the second mode, when for example, a monochrome image has to be displayed, it suffices to select only one of the different types of particles to be available to be moved into the image volume. As only one of the different types of particles has to be selected in the reservoir volume and only one fill period is required, either a higher refresh rate is possible in the second (monochrome video) display mode, or the power consumption decreases when the refresh rate is kept the same. Combinations of these two effects are of course also possible.

U.S. Pat. No. 6,445,323 discloses a digital driver for a LCD display. A mode of operation of the digital driver is controlled in accordance with format control signals. The different modes are: monochrome, color of various resolutions, and a one bit superimpose function. The format control signals are used to optimize the picture quality and the power consumption. In the monochrome mode the drive signals are supplied to LCD cells of a single color only. However, U.S. Pat. No. 6,445,323B1, by its LCD nature wherein each color is associated with a LCD pixel, does not disclose how to proceed when a display comprises pixels which each contain different types of electrophoretic particles which have different mobilities. Further, U.S. Pat. No. 6,445,323B1 does not disclose how the different types of particles have to be selected in a reservoir volume of the pixel and how these particles have to be selectively moved into the image volume of the pixel in accordance with the color the pixel should get. A LCD is completely differently controlled than an electrophoretic display, in a LCD display, the image disappears when the drive voltages are removed.

In an embodiment in accordance with the invention as claimed in claim 3, the driver adapts a refresh rate of the electrophoretic display during the second mode to obtain a display of the video information with a second refresh rate being higher than the first refresh rate occurring during the first mode. As explained earlier this allows improving the display of moving display information if this moving display information is displayed with colors allowing the use of a subset of the different types of particles.

In an embodiment in accordance with the invention as claimed in claim 4, the pixel is constructed and driven to address the different types of particles sequentially. Each addressing phase comprises a select phase and a fill phase. During each select phase one of the types of particles present in the reservoir volume is moved in front of the opening between the reservoir volume and the image volume such that these particles can be moved during the fill period into the image volume. The other particles are not in front of the opening and thus are obstructed to be moved into the image volume during the fill period. The actual amount of the selected type of particles which are moved into the image volume of a particular one of the pixels depends on the color this pixel should get in accordance with the image to be displayed.

Thus, during the first mode all the different types of particles have to be sequentially addressed during an address cycle per pixel. The refresh rate of the display is determined by the number of pixels of the display times the duration of the address cycle per pixel or per row of pixels. Usually, the pixels are selected row by row. Usually, the refresh rate further decreases due to a reset period which is required to reset all the pixels to the same optical state before they are addressed.

During the second mode at least one of the different types of particles need not be addressed because the associated color is not required in the image to be displayed. Thus, the total time to address the pixels will become much shorter as at least one address cycle (a select period and a fill period) less is required per pixel or row of pixels. Consequently, the refresh rate can be increased to better display video, or the power consumption will decrease because the drive of the display is inactive during part of the time.

In an embodiment in accordance with the invention as claimed in claim 5, only a single one of the different types of particles is addressed. This allows displaying monochrome information at a higher refresh rate or with lower power consumption.

In an embodiment in accordance with the invention as claimed in claim 6, only the type of particles is addressed which has the highest mobility. This minimizes the time required for addressing the pixels, for moving the particles from the reservoir volume into the image volume, and for resetting the particles from by moving them back to the reservoir volume.

In an embodiment in accordance with the invention as claimed in claim 7, select electrodes are present which generate in the reservoir volume a select electric field which separates the different types of particles in different sub-volumes in the reservoir volume. A voltage supplied between the select electrodes generates a select electric field which exerts a force on the particles. The particles will start moving due to this force with a speed which depends on the mobility of the particles. Within a particular time period that the select electric field is present, particles with a high mobility will move further than particles with a low mobility. In this manner, it is possible to separate the different particles in different sub-volumes of the reservoir volume.

Fill electrodes generate a fill electric field to move the different types of particles from the different sub-volumes into the image volume. The fill electric field moves the particles which are separated in the different sub-volumes into the image volume to determine the color of the pixel. The color of the pixel will depend on the time period the fill electric field is present. If the fill electric field is present for a short duration, much more particles with the highest mobility will be moved into the image volume than the particles with the lowest mobility. If the fill electric field is present for a long duration, all the particles will be moved into the image volume and thus different colors of the pixel are possible with a single image volume. It is not required to have several separate cells to obtain different colors. Consequently, if the image volume is equal to the volume of a prior art cell, the pixel in accordance with the invention will cover a smaller area and thus the resolution of the display can be higher. If the pixel volume of the pixel in accordance with the invention is equal to the volume of the several cells of a prior art pixel, the brightness may become higher, as the pixel boundaries occupy less pixel volume or area. Since the portion of each prior art pixel producing the desired color is smaller than in the present invention, the color will appear much less bright than if the entire pixel were able to produce the required color as is the case in the present invention.

Although the display in accordance with the invention as defined in claim 7 is able to provide different colors, it is not possible to make any possible combination of color shades of the different colors of the different particles.

In an embodiment as defined in claim 8, the at least one fill electrode is positioned to obtain a fill electric field directed to simultaneously move the different types of particles from the sub-volumes into the image volume. This has the advantage that the time required to fill the image volume with the particles decreases considerably.

In an embodiment as defined in claim 9, the fill electric field can be controlled for each type of particle separately, and thus, the number of particles of each type which are transported from the sub-volumes to the image volume can be freely controlled. Consequently, it is possible to make all color shades based on the different colors of the different particles. If not all the different types of particles are required to produce the image, only a subset need to be moved into the image volume. The select period may become shorter as it suffices that only the types of particles which may have to be moved into the image volume are moved in the reservoir volume until they can be moved into the image volume. A faster addressing and thus a higher refresh rate is possible, already if only the slowest type of particles is not used.

In an embodiment as claimed in claim 10, the pixel comprises a further reservoir volume. The pixel comprises further select electrodes and fill electrodes which are associated with the further reservoir in the same manner as the first mentioned select electrodes and the first mentioned fill electrodes are associated with the first mentioned reservoir volume. The function of the further reservoir volume is the same as the first mentioned reservoir volume. This embodiment has the advantage that the refresh rate of the display can be increased further because the selection process in one of the reservoirs can be performed in parallel with the filling or reset process from another reservoir as defined in claim 10. It is possible to associate more than two reservoirs with a same image volume.

In an embodiment as claimed in claim 12, the pixel comprises a further fill electrode which is positioned to enlarge the fill electric field in the image volume to speed up the filling of the visible part of the pixel by particles entering the image volume from the sub-volumes.

In an embodiment as claimed in claim 13, the distance of the further fill electrode to the sub-volumes varies such that the further fill electrode is nearest to the store volume in the reservoir volume. This has the advantage that a higher field is obtained for the particles such that the speed of movement of the particles increases and the filling time of the image volume decreases.

These and other aspects of the invention are apparent from and will be elucidated with reference to the embodiments described hereinafter.

In the drawings:

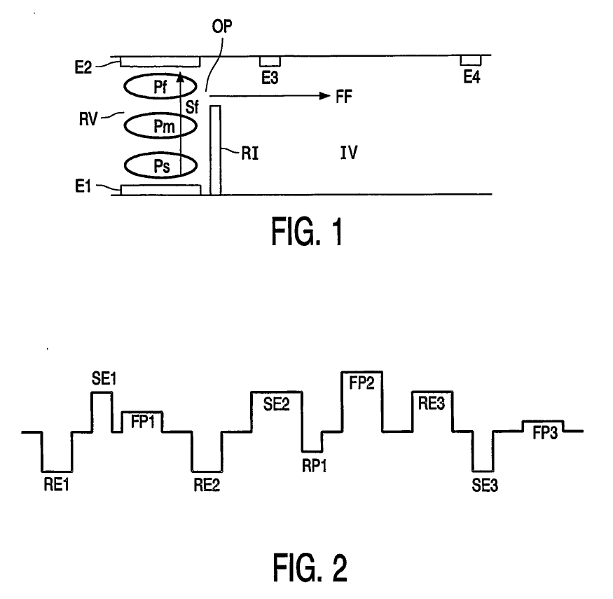

FIG. 1 shows a construction of a pixel of an electrophoretic display,

FIG. 2 shows waveforms for operating the pixel shown in FIG. 1 in a full color electrophoretic display,

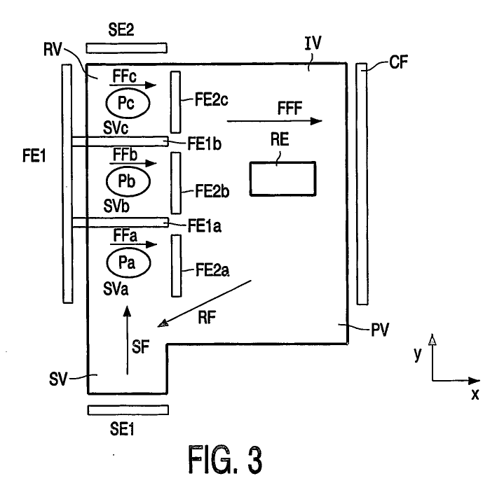

FIG. 3 shows another construction of a pixel of an electrophoretic display,

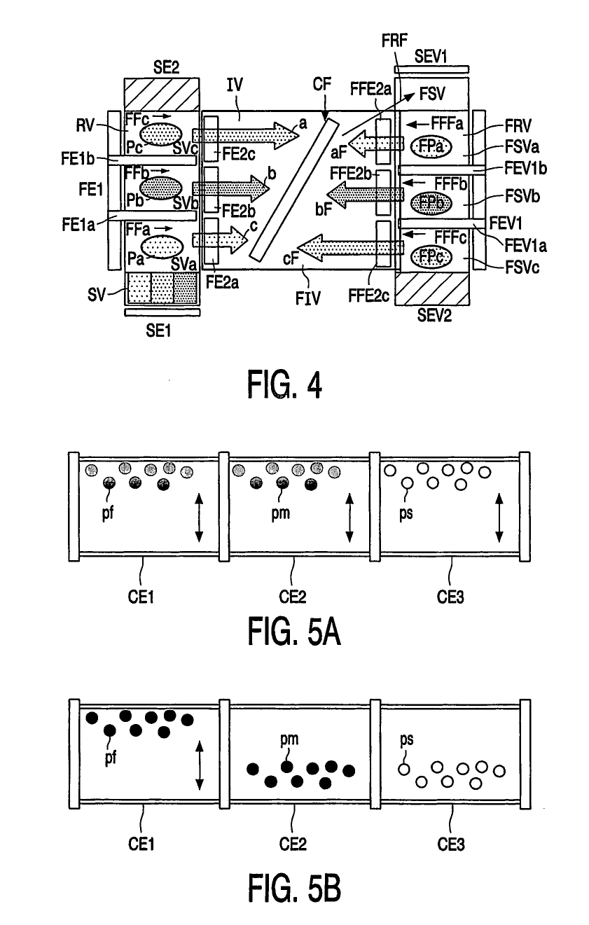

FIG. 4 shows another construction of a pixel of an electrophoretic display,

FIG. 5 shows another construction of a pixel of an electrophoretic display, and

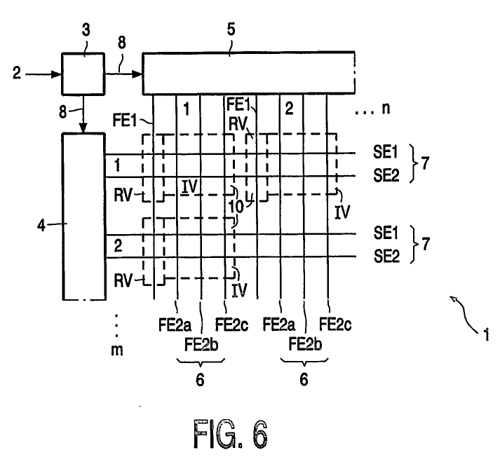

FIG. 6 shows a block diagram of a display apparatus with an electrophoretic matrix display of an embodiment in accordance with the invention.

FIG. 1 shows a construction of a pixel of an electrophoretic display. The pixel volume comprises a reservoir volume RV and an image volume IV. Three different types of particles Pf, Pm, Ps are present which have different colors and different mobilities. As elucidated with respect to FIG. 2, during a select period, the different types of particles Pf, Pm, Ps have to be selected in the reservoir volume RV one by one to be moved to the opening OP between the reservoir volume RV and the image volume IV. The particles Pf, Pm, Ps are moved by applying a select electric field SF in the reservoir volume RV. The rest of the reservoir volume RV and the image volume IV are separated by the rib RI. During a fill period, a fill electric field FF moves the particles present at the opening into the image volume Iv of the pixel, dependent on the color to be displayed. The select electrodes E1 and E2 are positioned with respect to the reservoir volume RV to be able to move the particles which, initially are attracted to the select electrode E1, towards the opening OP. The fill electrodes E3 and E4 are positioned with respect to the image volume IV to move the selected particles which are near the opening OP into the image volume IV during the fill period, or to move the particles which are in the image volume IV back into the reservoir volume during a reset period. The operation of the pixel is elucidated in more detail with respect to FIG. 2.

FIG. 2 shows waveforms for operating the pixel shown in FIG. 1 in a full color electrophoretic display.

First is elucidated how the electrophoretic display is operated in the first mode wherein polychrome information is displayed and all the types of particles may contribute to a change of color of the cells.

In a first step, a reset pulse RE1 is supplied to the select electrode E1 to gather all the particles Pf, Pm, Ps near the select electrode E1. If the particles Pf, Pm, Ps are negatively charged, the reset pulse RE should be positive. Next a voltage pulse SE1 is supplied between the select electrodes E1 and E2 such that the select electrode E2 is positive with respect to the select electrode E1 and the all the particles Pf, Pm, Ps are attracted towards the select electrode E2. When the fastest particles Pf (for example the cyan colored particles) arrive at the opening OP near the select electrode E2, the voltage pulse SE1 on the select electrode E2 is switched off. The other slower particle types have not yet arrived at the opening OP. Then, the fastest particles Pf can be drawn into the image volume IV of the pixel by means of the electric field generated by the fill pulse FP1 on the fill electrodes E3 and E4. The other particles Pm and Ps will not be drawn into the image volume IV by the electric field generated by the fill electrodes E3 and E4 because they are obstructed by the rib RI.

In a second step, a second reset pulse RE2 is supplied to the select electrode E1 to gather all the particles Pf, Pm, Ps near the select electrode E1. Then, a voltage pulse SE2 is supplied to the select electrode E2 during a longer period in time required to move both the fastest particles Pf and the particles Pm with the medium mobility to the opening OP. Now a short repulsive pulse RP1 is supplied to the select electrode E2, or a short attractive pulse RP1 is supplied to the select electrode E1 to move the fastest particles Pf (for example colored cyan) back towards the direction of the electrode E1. The particles Pm with the medium mobility (for example colored magenta) have hardly had time to move away from the opening O2 so that they can be drawn into the image volume IV by an appropriate voltage pulse FP2 on the fill electrodes E3 and E4 during the fill period.

The last step, is to address the slowest particles Ps (for example colored yellow). First, the select electrode E2 receives a voltage pulse RE3 for a third reset wherein all the particles Pf, Pm, Ps are gathered near the select electrode E2. Then, a voltage pulse SE3 is supplied to the select electrode E1 to move the two fastest kinds of particles (cyan and magenta) away from the select electrode E2 in the direction of the select electrode E1, whereas the slowest yellow particles Ps remain near to the select electrode E2 and thus near to the opening OP. A voltage pulse FP3 on the fill electrodes E3 and E4 will move these yellow particles Ps into the image volume IV during the fill period.

Thus, to be able to operate the electrophoretic display in the first mode wherein polychrome information is displayed, all the particles Pf, Pm, Ps have to be sequentially selected in the reservoir volume RV and moved into the image volume IV in accordance with the color to be displayed. All these sequential steps have to be performed before a next color in accordance with the polychrome information can be displayed by the same pixel or cell. A refresh time of the electrophoretic display is thus limited by the time required to perform these three sequential steps.

The electrophoretic display is operated in a second mode wherein information is displayed with a reduced amount of colors and thus not all the types of particles are required. Now, less of steps have to be performed than with respect to the display of polychrome information wherein all the types of particles have to be used.

In the special situation that monochrome information has to displayed it suffices to use a single type of the particles. It is only required to select a single type of particles and to move these particles into the image volume IV in accordance with the monochrome information to be displayed. Preferably, only the fastest particles are selected to be moved into the image volume IV. The refresh time will become much shorter as only one type of particles has to be selected and moved into the image volume IV. Thus, the monochrome information is displayed with a higher refresh rate than the polychrome information. This minimizes flicker artifacts which are particular disturbing when reading large amounts (of non-moving) text. The increased rate of update of images reduces the blurring of moving images. Alternatively, it is possible to keep the refresh rate unaltered to obtain lower power consumption.

FIG. 3 shows another construction of a pixel of an electrophoretic display. The pixel has a pixel volume PV which comprises a reservoir volume RV and an image volume IV. In the pixel, three differently colored particles Pa, Pb, Pc with a different electrophoretic mobility are present. The visible color of the pixel is determined by the amount of the particles Pa, Pb, Pc which is present in the image volume IV. Preferably, the colors of the particles are selected to be able to produce a maximum amount of hues. For example, the particles are colored yellow, magenta and cyan. The select electrodes SE1 and SE2 are present at opposite sides of the reservoir volume RV to generate a select electric field SF (further also referred to as select field SF) in the reservoir volume RV in the y-direction. The fill electrodes FE1 and FE2 are present in a plane which is perpendicular to the plane in which the select electrodes SE1 and SE2 are present. The fill electrodes FE1 and FE2 generate a fill electric field FF (further also referred to as fill field FF) in the x-direction perpendicular to the y-direction.

In general, all electrodes can be formed as thin conducting layers situated on one of the substrate layers of which the cell is comprised. The electrodes, and in particular the fill electrode FE2 may also be in the form of barriers, having many small holes or a few large holes to allow the particles Pa, Pb, Pc to pass, or the fill electrode FE2 may comprise at least one strip.

To enable a rendering of different polychrome pictures on the display, the pixel is driven as elucidated in the following description.

At the start of a display period (also referred to as refresh period) of the pixel wherein the color of the pixel has to be adapted in conformance with the data to be displayed during this display period, during a reset phase, all colored particles Pa, Pb, Pc which were moved into the image volume IV in accordance with previous image data are removed from the image volume IV into the store volume SV of the reservoir volume RV by using an attractive voltage pulse on the select electrode SE1 to generate an electric field RF. Thus, in an initial state, the colored particles Pa, Pb, Pc are stored in the store volume SV such that all the particles Pa, Pb, Pc have a substantially same starting position.

During the select phase, the particles Pa, Pb, Pc are separated within the reservoir volume RV using an attractive voltage pulse between the select electrodes SE1 and SE2 to attract the particles Pa, Pb, Pc towards the select electrode SE2. The most mobile particles Pc move the farthest, the particles Pa with the lowest mobility move over the smallest distance, the particles Pb with an in-between mobility move over a distance in-between the other distances. Thus, after the voltage pulse has been present between the select electrodes SE1 and SE2 during a suitable duration, the particles Pa, Pb, Pc are separated: the particles Pa are substantially present in the sub-volume SVa, the particles Pb are substantially present in the sub-volume SVb, and the particles Pc are substantially present in the sub-volume SVc, as is shown in FIG. 3. The sub-volumes SVa, SVb, SVc are schematically indicated by ellipsoids.

During the fill phase, all particles Pa, Pb, Pc are moved simultaneously from the sub-volumes SVa, SVb, SVc of the reservoir volume RV to the image volume IV using an attractive voltage pulse between the fill electrodes FE1 and FE2. As soon as sufficient particles Pa, Pb, Pc have entered the pixel volume PV, the attractive voltage pulse is removed from the fill electrodes FE1 and FE2.

As the particles Pa, Pb, Pc are moved simultaneously from the reservoir volume RV to the image volume IV, the refresh time of the pixel can be kept quite short. Once the particles Pa, Pb, Pc are within the image volume IV, they will be held there by a small repulsive voltage on the fill electrode FE2 until the next refresh period. During this image hold time, the particles Pa, Pb, Pc can mix by Brownian motion, or, when needed, (AC) electrical signals can be used to effectuate particle mixing inside the pixel.

Preferably, as shown, the fill electrode FE2 comprises three sub fill electrodes FE2a, FE2b, FE2c to generate a fill field which has three sub-fill fields FFa, FFb, FFc in the sub-volumes SVa, SVb, SVc, respectively. Thus now, three different (in strength and/or duration) fill electric fields FFa, FFb, FFc may be present, allowing to separately control the amount of particles Pa, Pb, Pc which will be moved into the image volume IV.

Preferably, the fill electrode FE1 comprises arms FE1a and FE1b which extend in the x-direction. These arms FE1a and FE1b shield the fill fields FFa, FFb, FFc occurring in adjacent ones of the sub-volumes SVa, SVb, SVc from each other. This reduces cross-talk effects in controlling the amount of particles Pa, Pb, Pc which have to leave the sub-volumes SVa, SVb, SVc. In a preferred embodiment, FE1a and FE1b are implemented as separate electrodes which may have individually definable voltages. This further increases the efficiency of selecting particles and filling the image volume.

A further fill electrode CF may be present to speed up the filling of the image volume IV by generating a further fill field FFF in the image volume IV to attract the particles Pa, Pb, Pc further into the image volume IV.

As soon as sufficient particles Pa, Pb, Pc have entered the image volume IV (i.e passed the smaller fill electrodes FE2a, FE2b, FE2c) excess particles Pa, Pb, Pc may be sent back using these smaller pixel electrodes FE2a, FE2b, FE2c.

The arrow RF indicates the electric field required to the move the particles Pa, Pb, Pc into the store volume SV during the reset phase of the pixel when a high voltage is present on the select electrode SE1. The display may be constructed such that a high voltage can be supplied directly to the select electrode SE1 to speed up the reset phase. If the voltage has to be supplied to the select electrodes via TFT's, the voltage level will be limited.

It is also possible to add a reset electrode, for example in the image volume IV, to increase the field which directs the particles Pa, Pb, Pc back into the reservoir RE. Preferably this extra reset electrode is positioned in the center of the image volume IV. During the reset phase, first a voltage is supplied to the extra reset electrode to concentrate the particles Pa, Pb, Pc in the center of the pixel and then, a voltage is supplied to the select electrode SE1 to attract the particles Pa, Pb, Pc into the store volume SV. Alternatively, one of the existing electrodes, for example FE2a, may temporarily take the function of an additional reset electrode during the reset phase.

In the geometry of the reservoir volume RV shown in FIG. 3, the mobility of the slowest particle Pa is typically three times lower than that of the fastest particle Pc. It is possible to change the geometry of the reservoir volume RV such that a distance from the store volume SV to the sub-volumes becomes much larger. Due to the long reservoir, the particles Pa, Pb, Pc can be separated even if the difference in the mobility is far smaller. For example, the mobility of the slowest particle Pa can be selected to be 75% of the mobility of the fastest particle Pc. Consequently, as the mobility of the slowest particle Pa is much higher, the time required to fill the image volume IV and the time to move the particles Pa, Pb, Pc back into the store volume SV decreases considerably.

In the second mode wherein the electrophoretic display is operated to display monochrome information, the drive of the electrophoretic display is adapted such that only the particles Pf with the highest mobility are selected to be moved into the image volume IV. This is realized by applying the voltage between the select electrodes SE1 and SE2 during a shorter time than in the polychrome mode such that the fastest particles Pf are moved into the sub-volume SVa, while the other, slower, particles Pm and Ps are still in the store volume SV. The fastest particles Pf in the sub-volume SVa are then moved into the image volume IV. As only the fastest particles Pf need to be moved into the image volume IV, also the duration of the fill period will be shorter than in the polychrome mode.

It is also possible to use the particles with the highest and with the medium mobility instead all the particle types. Still, the total time required to select and move these two type of particles into the image volume IV is shorter than when the electrophoretic display is operated in the polychrome mode wherein all the types of particles, thus also the slowest, have to be selected and moved. Thus, it is possible to display the information which does not require all the types of particles to be moved into the image volume IV with a higher refresh rate than the polychrome information, or to decrease the power consumption. The gain is largest when monochrome information is displayed by using only the fastest particles.

FIG. 4 shows another construction of a pixel of an electrophoretic display.

The pixel shown in FIG. 4 is based or the pixel shown in FIG. 3 wherein the further fill electrode CF is removed and a second reservoir FRV is added positioned opposite to the reservoir RV. The construction of the reservoir FRV may be identical to the construction of the reservoir RV.

Because the pixel should be constructed to allow display of polychrome information, the construction of the pixel which is able to display a full color picture is discussed. In such a pixel at least three particles should be present having primary colors.

The extra reservoir FRV comprises: the select electrodes SEV1 and SEV2, three sub-fill electrodes FFE2a, FFE2b, FFE2c to generate the sub-fill fields FFFa, FFFb, FFFc in the sub-volumes FSVa, FSVb, FSVc, respectively. Thus again, three different (in strength and/or duration) fill electric fields FFFa, FFFb, FFFc may be present, allowing to separately control the amount of particles FPa, FPb, FPc which will be moved from the reservoir volume FRV into the image volume IV. In this case, sub-fill electrodes FE2a, FE2b, FE2c can temporarily take the role of the further fill electrode CF to speed up the filling of the image volume IV by generating a further fill field FFF in the image volume IV to attract the particles further into the image volume IV.

The fill electrode FEV1 comprises arms FFE1b and FFE1a which extend in the x-direction. These arms FFE1a and FFE1b shield the fill fields FFFa, FFFb, FFFc occurring in adjacent ones of the sub-volumes FSVa, FSVb, FSVc from each other. This reduces cross-talk effects in controlling the amount of particles FPa, FPb, FPc which have to leave the sub-volumes FSVa, FSVb, FSVc.

During the reset period of the extra reservoir volume FRV, the particles FPa, FPb, FPc are attracted by the store field FRF into the store volume FSV.

The arrows indicated by aF, bF, cF show the movement of the particles FPa, FPb, FPc, respectively, during the fill phase of the image volume IV from the reservoir FRV.

The embodiment in accordance with the invention as shown in FIG. 3 has the drawback that after removing the particles from the pixel volume PV during the reset phase, it is first necessary to select the particles Pa, Pb, Pc before the image volume IV can be filled.

In the preferred embodiment as shown in FIG. 4, the image volume IV will be in contact with two reservoir volumes SV and FSV, whereby the particles FPa, FPb, FPc are reset into the store volume FSV of the reservoir volume FRV, and the particles Pa, Pb, Pc are selected in the other reservoir volume RV. In this manner, the separation of the particles Pa, Pb, Pc (the color selection) can be carried out prior to the start of the refresh period of the other reservoir volume FRV. It is then possible to move directly from the reset phase for the reservoir volume FRV to the fill phase from the reservoir RV, thereby further reducing the refresh time.

This is also useful to further increase the refresh rate in the monochrome mode wherein only the fastest particles Pf are used to fill the image volume IV.

The optional fill electrode CF is positioned slanted with respect to the reservoir RV such that the distance to the particles Pa, FPa in the sub-volume SVa, FSVa, respectively, is shorter than the distance to the particles Pc, FPc in the sub-volume SVc, FSVc, respectively. The dimensions of the image volume IV are the same. In this construction, the electrical field for pulling the particles out of the sub-volumes SVa or FSVa is larger. This is advantageous in the polychrome mode wherein all the types of particles are used to speed up the movement of the slowest particles Ps and also during the monochrome mode (or a mode wherein not all the types of particles are used) to speed up the movement of the fastest particles Pf (or the types of particles used). Thus again, the refresh rate can be further increased.

FIG. 5 shows another construction of a pixel of an electrophoretic display. Now, each pixel comprises three sub-pixels. Each sub-pixel contains a different types of particles dissolved in a solvent containing a black dye. Particles near the top electrode are visible to the observer. The fastest particles Pf are present in display cell CE1, the slowest particles Ps are present in the display cell CE3, and the particles with the intermediate mobility are present in the display cell CE2.

FIG. 5A shows the full color operation wherein all the different types of particles may have to be moved dependent on the color in accordance with the image to be displayed the pixel should have. In FIG. 5B only the fastest particles Pf are used, the other particle types remain set to their black state. Although it is possible to display a monochrome image only, the refresh rate can be increased significantly, as the slower particles do not hamper the speed of operation of the electrophoretic display.

More general, a higher refresh rate is possible as soon as the slowest particle is not used and thus no address cycle for this particle is required.

FIG. 6 shows a block diagram of a display apparatus with an electrophoretic matrix display of an embodiment in accordance with the invention. The display 1 comprises a matrix of pixels 10 at intersections of crossings row or selection electrodes 7 and column or data electrodes 6. Two select electrodes SE1, SE2 and four data electrodes FE1, FE2a, FE2b, FE2c correspond to one pixel 10. The select electrodes SE1 may be interconnected. The data electrodes FE1 may also be interconnected.

The rows 1 to m of the pixels 10 are consecutively selected by means of a row driver 4, while the groups of column electrodes 1 to n are provided with data via a data register 5. Each pixel 10 comprises a reservoir volume RV and an image volume IV. A full color pixel 10 comprises only a single image volume IV.

The incoming data 2 are first processed, if necessary, in a data processor 3. Mutual synchronization between the row driver 4 and the data register 5 takes place via drive lines 8.

Drive signals from the row driver 4 are supplied to the select electrodes SE1 and SE2 to separate the particles Pa, Pb, Pc in the sub-volumes SVa, SVb, SVc during the select period, and to move the particles Pa, Pb, Pc back into the store volume SV during the reset phase.

Drive signals from the data driver 5 are supplied to the fill electrodes FE1, FE2a, FE2b, FE2c to move the separated particles Pa, Pb, Pc from the reservoir volume RV into the image volume IV. The voltage on the extra fill electrode CF, when present, may also be supplied by the data driver 5.

Such driving may be suitable for small matrix or segmented displays. More generally however, the display will be driven by an active matrix, comprising thin film transistors (TFTs), diodes or other active elements. In the case of a TFT active matrix, each pixel will further comprise a multiplicity of addressing (or selection) TFTs. A line of pixels is selected by applying a pulsed voltage to the addressing TFTs, whereby these become conductive and connect the electrodes in the pixel to data signals being generated by the data driver 5. It is also possible that some electrodes are common to a multiplicity of pixels.

The known drive is easily adapted to cater for the use of less than all types of particles. In the sequentially driven display of FIGS. 1 and 2, the sequence of voltages for the type of particles not used is left out. In the parallel driven display of FIGS. 3 to 4, only the fastest types of particles are used. The selection of the particles is performed by using a shorter select time such that only the particles to be moved into the image volume IV are moved out of the store volume SV. Also the filling and resetting is performed during shorter periods of time, as at least the slowest particles are not anymore used. In the display in which a pixel comprises three sub-pixels, the drive is adapted to address one of the sub-pixels only.

It should be noted that the above-mentioned embodiments illustrate rather than limit the invention, and that those skilled in the art will be able to design many alternative embodiments without departing from the scope of the appended claims.

For example, it is not essential to the invention that three different types of particles are present, what matters is that different types of particles are present. In the sequential addressed display, the advantages of a higher refresh time or less dissipation are reached if less than all the particle types are selected. In the parallel addressed display the advantages are reached if at least one of the particle types which does not have the lowest mobility to display information is selected. The particles may be positively charged instead of negatively. It is also possible to combine positively and negatively charged particles.

In the claims, any reference signs placed between parentheses shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. A color electrophoretic display comprising:
pixels each comprising different types of particles (Pf, Pm, Ps; Pa, Pb, Pc) having different colors and different electrophoretic mobilities, and
a driver (4, 5) for supplying drive voltages to the pixels to operate the color electrophoretic display either in:
a first mode wherein all the types of particles (Pf, Pm, Ps; Pa, Pb, Pc) contribute to a change of color of at least some of the pixels, or
a second mode wherein only a subset of the types of particles (Pf, Pm, Ps; Pa, Pb, Pc) contribute to the change of the color of at least some of the pixels.

2. A color electrophoretic display as claimed in claim 1, wherein the pixels each comprise an image volume (IV) and a reservoir volume (RV), and wherein the different types of particles (Pf, Pm, Ps; Pa, Pb, Pc) determine a visible color of the pixel (10) when present in the image volume (IV), and wherein the particles (Pf, Pm, Ps; Pa, Pb, Pc) do not contribute to the visible color of the pixel (10) when present in the reservoir volume (RV).

3. A color electrophoretic display as claimed in claim 1, wherein the driver (4, 5) comprises means (4, 5) for adapting a refresh rate of the electrophoretic display during the second mode to obtain a display of the video information with a second refresh rate being higher than the first refresh rate occurring during the first mode.

4. A color electrophoretic display as claimed in claim 2, wherein the reservoir volume (RV) comprises select electrodes (E1, E2) for generating a select electric field (SF) in the reservoir volume (RV), wherein the image volume (IV) comprises fill electrodes (E3, E4) for generating a fill electric field (FF) in the image volume (IV), the select electric field (SF) extending in a first direction (y), the fill electric field (FF) extending in a second direction (x) not being aligned with the first direction (y), and wherein the particles (Pf, Pm, Ps) are able to move from the reservoir volume (RV) to the image volume (IV) only locally along a distance between the select electrodes (E1, E2), the driver (4, 5) being adapted to supply voltage pulses to the select electrodes (E1, E2) and the fill electrodes (E3, E4) to move the different groups of particles (Pf, Pm, Ps) sequentially into the image volume (IV).

5. A color electrophoretic display as claimed in claim 4, wherein the driver is adapted for selecting only a single one of the different types of particles (Pf, Pm, Ps) during the second mode, and to move these particles (Pf, Pm, Ps) into the image volume (IV) in accordance with a monochrome image to be displayed.

6. A color electrophoretic display as claimed in claim 5, wherein the particles (Pf, Pm, Ps) of the single one of the different types of particles are the particles (Pf) having the highest mobility.

7. A color electrophoretic display as claimed in claim 2, further comprising
select electrodes (SE1, SE2) for generating in the reservoir volume (RV) a select electric field (SF) for separating the different types of particles (Pa, Pb, Pc) in different sub-volumes (SVa, SVb, SVc) in the reservoir volume (RV), and
at least one fill electrode (FE1, FE2) for generating a fill electric field (FF) to move the different types of particles (Pa, Pb, Pc) from the sub-volumes (SVa, SVb, SVc) into the image volume (IV).

8. An electrophoretic display as claimed in claim 7, wherein the at least one fill electrode (FE1, FE2) is positioned to obtain the fill electric field (FF) directed for simultaneously moving the different types of particles (Pa, Pb, Pc) from the sub-volumes (SVa, SVb, SVc) into the image volume (IV).

9. An electrophoretic display as claimed in claim 7, wherein the fill electrodes (FE2) comprise sub fill electrodes (FE2a, FE2b, FE2c) associated with the different sub-volumes (SVa, SVb, SVc) for generating the fill electric field (FF) to comprise sub fill electric fields (FFa, FFb, FFc) in the different sub-volumes (SVa, SVb, SVc).

10. An electrophoretic display as claimed in claim 7, further comprising:
a further reservoir volume (FRV),
further select electrodes (SEV1, SEV2) for generating in the further reservoir volume (FRV) a further select electric field (SFV) for separating the different types of particles (FPa, FPb, FPc) in further different sub-volumes (FSVa, FSVb, FSVc) in the further reservoir volume (FRV), and
further fill electrodes (FFE2a, FFE2b, FFE2c) for generating a further fill electric field (FFFa, FFFb, FFFc) to simultaneously or time sequentially move the different types of particles (FPa, FPb, FPc) from the further sub-volumes (FSVa, FSVb, FSVc) into the image volume (IV).

11. An electrophoretic display as claimed in claim 7, wherein the electrophoretic display comprises a controller for controlling the first mentioned select electrodes (SE1, SE2), the at least one first mentioned fill electrode (FE1, FE2), the further select electrodes (SEV1, SEV2), and the further fill electrodes (FFE2a, FFE2b, FFE2c) to obtain a separation of the different types of particles (Pa, Pb, Pc) in the first mentioned reservoir volume (RV) simultaneously to filling or resetting particles (FPa, FPb, FPc) to or from the further reservoir volume (FRV), or the other way around.

12. An electrophoretic display as claimed in claim 11, wherein the pixel (10) comprises a further fill electrode (CF) arranged in the image volume (IV) in the second direction further away from the reservoir volume (RV) than the sub fill electrodes (FE2a, FE2b, FE2c) for attracting the particles (Pa, Pb, Pc) leaving the sub-volumes (SVa, SVb, SVc) further into the image volume (IV).

13. An electrophoretic display (1) as claimed in claim 12, wherein the further fill electrode (CF) is positioned with respect to the sub-volumes (SVa, SVb, SVc) to obtain a smallest distance towards the sub-volume (SVa) nearest to a store volume (SV) in the reservoir volume (RV).

14. A method of driving a color electrophoretic display having pixels comprising different types of particles (Pf, Pm, Ps; Pa, Pb, Pc) having different colors and different electrophoretic mobilities, the method comprising supplying (4, 5) drive voltages to the pixels to operate the color electrophoretic display either in:
a first mode wherein all the types of particles (Pf, Pm, Ps; Pa, Pb, Pc) contribute to a change of color of at least some of the pixels, or
a second mode wherein only a subset of the types of particles (Pf, Pm, Ps; Pa, Pb, Pc) contribute to the change of the color of at least some of the pixels.

15. A method as claimed in claim 14, wherein the pixels each comprise an image volume (IV) and a reservoir volume (RV), and wherein the particles (Pf, Pm, Ps; Pa, Pb, Pc) determine a visible color of the pixel (10) when present in the image volume (IV), and wherein the particles (Pf, Pm, Ps; Pa, Pb, Pc) do not contribute to the visible color of the pixel (10) when present in the reservoir volume (RV).

16. A display apparatus comprising a color electrophoretic display as claimed in claim 1.
